(19) United States
(12) Patent Application Publication
(10) Pub. No.: US 2020/0306893 A1
(43) Pub. Date: Oct. 1, 2020

(54) SOLDER PASTE AND MOUNT STRUCTURE

(71) Applicant: Panasonic Intellectual Property Management Co., Ltd., Osaka (JP)

(72) Inventors: YASUHIRO SUZUKI, Osaka (JP); HIROHISA HINO, Osaka (JP); SHIGERU YAMATSU, Osaka (JP)

(21) Appl. No.: 16/792,654

(22) Filed: Feb. 17, 2020

(30) Foreign Application Priority Data
Mar. 28, 2019 (JP) 2019-064525

(51) Int. Cl. B23K 35/02; B23K 35/26

(52) U.S. Cl. CPC B23K 35/025; C22C 13/00; B23K 35/262

(57) ABSTRACT

Provided herein is a solder paste that can be used for solder connection requiring a high melting point, while, at the same time, ensuring excellent applicability, high adhesion, and excellent solder joint reliability. A mount structure mounting an electronic component with such a solder paste is also provided. The solder paste is a solder paste that includes a solder powder and a flux. The flux contains an epoxy resin, a phenolic resin, a benzooxazine compound, and an activating agent. The phenolic resin contains at least one type of phenolic resin having a phenolic hydroxyl group and an allyl group within the molecule.

### TECHNICAL FIELD

The technical field relates mainly to solder pastes used for soldering of semiconductor components, electronic components, and the like to a circuit board, particularly a solder paste that contains an epoxy resin as a flux component. The technical field also relates to a mount structure.

### BACKGROUND

Mobile devices such as cell phones and PDAs (Personal Digital Assistants) have never been smaller and more functional. A variety of mount structures such as BGA (Ball Grid Array), and CSP (Chip Scale Package) are available as a mount technology for accommodating such advancements. Mobile devices are often subjected to a mechanical load such as dropping impact. A QFP (Quad Flat Package) absorbs impact at its lead portion. BGA and CSP do not have leads that relieve impact, and it is important to provide reliability against impact in these structures. Particularly, heat cycle resistance and heat resistance have become increasing important in today's high-functional and high-power-performance conductive devices. For automotive applications, such mount structures are required to have high vibration resistance, and high heat resistance necessitated by installation of semiconductor devices in an engine room. To this end, high solder joint reliability is necessary for mounted devices, and there is a need for a structural technique and a solder material capable of satisfying such requirements.

Use of underfill material for BGA and CSP mounting is commonly practiced as a structural technique intended to improve solder joint reliability. A mount structure using underfill material is a technique that joins an electronic component and a circuit board to each other by melting a solder ball (for example, a Sn—Ag—Cu-base solder ball), and fills the periphery of the solder with an epoxy resin or the like. An underfilled electronic component has resin covering the periphery of the solder, allowing thermal expansion and contraction, vibration, and external forces such as dropping stress to spread out to the resin around the solder so that these forces do not concentrate on the solder. In this way, the joint can exhibit high reliability. However, such a mounting technique requires the underfill material to fill the gap of about several tens of micrometers between the electronic component and the circuit board by capillary action. This increases the mounting time per device. The subsequent thermal curing of the underfill material also adds to the process time, and increases the cost.

This issue is addressed in related art. For example, Japanese Patent No. 5204241 proposes a semiconductor mount structure using a solder paste that contains a thermosetting resin in the flux, and a method for producing such a semiconductor mount structure.

Such a solder paste containing a thermosetting resin (hereinafter, also referred to simply as “solder paste”) forms a reinforcing structure as the resin, contained in the flux, separates from the solder being heated and melted in a bonding step, and covers the periphery of the solder. As a result of reinforcement, the solder connection can increase its strength.

In mounting using the solder paste, the solder paste is heated with a reflow furnace after components such as wire electrodes of a circuit board are printed on predetermined positions using a metal mask. In heating of the solder paste, the flux acts to chemically remove the oxide film on the metal surface to be soldered, and the surface oxide film of the solder powder in a reduction reaction (activity known as “fluxing effect”), enabling melting and bonding of the solder. This is followed by curing of the thermosetting resin, for example, an epoxy resin, joining the wire electrodes of the circuit board to an electronic component while the resin provides reinforcement, all in a single heat reflow process.

Traditionally, Pb eutectic solders are used as solder material. However, the growing environmental concerns have led to the use of lead-free solders. A variety of lead-free solders are available, including, for example, Sn—Bi-base solders, Sn—Ag—Cu-base solders (hereinafter, also referred to simply as “SAC solders”), and Sn—Cu-base solders. The SAC solder has been used in practical mounting applications to achieve high joint reliability, as exemplified by SAC solders of different metal compositions containing indium. Well-studied examples of the SAC solder include SAC305 (Sn-3.0Ag-0.5Cu) solder (hereinafter, also referred to simply as “SAC305 solder”), and SAC105 (Sn-1.0Ag-0.5Cu) solder of a lower silver content (1% silver) (hereinafter, also referred to simply as “SAC105 solder”), and these are gradually being put to practical applications.

As mentioned above, a solder paste containing a thermosetting resin in its flux can improve joint reliability with the reinforcing structure formed by resin, without increasing the process time or cost. However, such solder pastes available for use in practical applications are low-melting-point solders, such as the Sn—Bi-base solder disclosed in the foregoing related art. For example, a thermosetting resin-containing solder paste using a high-melting-point solder such as a SAC solder is almost nonexistent in the market.

### SUMMARY

Specifically, a low-melting-point Sn—Bi-base solder such as that disclosed in the foregoing patent has a melting point of about 139° C., and the epoxy resin, which is a thermosetting resin, undergoes curing after melting of the solder. This enables formation of a desirable solder joint portion (conductive portion) and a desirable resin reinforced portion. On the other hand, the SAC305 solder has a melting point of about 219° C., and, in order to sufficiently melt the solder within the reflow profile, the peak temperature of the mounting reflow furnace needs to be raised to, for example, 240 to 260° C. As a rule, the epoxy resin—a thermosetting resin contained in the flux of a solder paste—starts a curing reaction at 100 to 150° C. Accordingly, the epoxy resin starts curing and thickens before the solder particles dispersed in the solder paste melt and agglomerate in the reflow profile, with the result that desirable formation of a solder joint portion becomes difficult to achieve. The epoxy resin also has a curing rate that is much faster in a high temperature range of about 200° C. than in a temperature range of about 150° C., and quickly solidifies in such a fast-curing temperature range. It is indeed very difficult to form a solder joint portion and a resin reinforced portion with a solder paste containing a thermosetting resin, particularly when the solder has a high melting point.

There is accordingly a need for a solder paste that can desirably form a solder joint portion and a resin reinforced portion even with a reflow profile involving a high melting point.

It is accordingly an object of the present disclosure to provide a solder paste that can be used for solder connection requiring a high melting point, while, at the same time, ensuring excellent applicability, high adhesion, and excellent solder joint reliability. The present disclosure is also intended to provide a mount structure mounting an electronic component with such a solder paste.

Curing of resin hardly takes place in a mixture containing only an epoxy resin and a phenolic resin without a curing promoting agent commonly used to promote curing of epoxy resin in a low temperature region of about 150° C., for example, even when the mixture is heated at a high temperature of about 240° C. for 1 hour. However, it was found that curing of resin occurs at a high temperature of about 240° C. and in a short time period of only about several minutes when an appropriate amount of benzooxazine compound is added to such a mixture. It was also found that a more desirable solder paste can be obtained when an appropriate amount of activating agent is added to the mixture to produce the fluxing effect, in addition to the benzooxazine compound. Another finding is that the adhesion of the cured product greatly improves when the mixture additionally contains a phenolic resin having an allyl group.

According to a first gist of the present disclosure, there is provided a solder paste including a solder powder and a flux, the flux containing an epoxy resin, a phenolic resin, a benzooxazine compound, and an activating agent, the phenolic resin containing at least one type of phenolic resin having a phenolic hydroxyl group and an allyl group within the molecule.

In an aspect of the first gist of the present disclosure, the number of moles of an epoxy group contained in the epoxy resin, the number of moles of the phenolic hydroxyl group, and the number of moles of a dihydrobenzooxazine ring contained in the benzooxazine compound may satisfy the following ratio,

(number of moles of the epoxy group):(number of moles of the phenolic hydroxyl group):(number of moles of the dihydrobenzooxazine ring)=100:50 to 124:6 to 50.

In an aspect of the first gist of the present disclosure, the number of moles of the epoxy group, and the sum of the number of moles of the phenolic hydroxyl group and the number of moles of the dihydrobenzooxazine ring may satisfy the following formula,

{(number of moles of the phenolic hydroxyl group)+(number of moles of the dihydrobenzooxazine ring)}/(number of moles of the epoxy group)=0.5 to 1.3.

In an aspect of the first gist of the present disclosure, the phenolic resin may contain a phenolic resin having no allyl group in an amount of 40 mass % or less with respect to a total phenolic resin amount.

In an aspect of the first gist of the present disclosure, the benzooxazine compound may be a polyvalent oxazine having a plurality of dihydrobenzooxazine rings within the molecule.

In an aspect of the first gist of the present disclosure, the solder powder may be a Sn—Ag—Cu— or a Sn—Cu-base solder having a melting point of 200° C. or more.

In an aspect of the first gist of the present disclosure, the solder powder may be contained in a proportion of 5 mass % to 95 mass % with respect to a total mass of the solder paste.

In an aspect of the first gist of the present disclosure, the solder paste may further include a reactive diluent, and the reactive diluent may be 1,3-bis[(2,3-epoxypropyl)oxy]benzene.

In an aspect of the first gist of the present disclosure, the activating agent may be an organic acid, and the organic acid may have a melting point of 130° C. to 220° C.

According to a second gist of the present disclosure, there is provided amount structure in which an electronic component is mounted on a circuit board with the solder paste of the first gist of the present disclosure,

the mount structure including:

a conductive portion where the electronic component and the circuit board are metallurgically bonded to each other; and

a reinforcing portion formed by a cured product of the flux covering a periphery of the conductive portion.

A solder paste of the present disclosure can be used for solder connection requiring a high melting point, while, at the same time, ensuring excellent applicability, high adhesion, and excellent solder joint reliability.

### BRIEF DESCRIPTION OF THE DRAWINGS

FIG. 1 is a cross sectional view of a CSP solder joint portion bonded with a solder paste of an embodiment of the present disclosure.

FIG. 2A is a cross sectional explanatory diagram schematically representing a process for joining a ball portion of a CSP with the solder paste of the embodiment of the present disclosure.

FIG. 2B is a cross sectional explanatory diagram schematically representing a process for joining a ball portion of a CSP with the solder paste of the embodiment of the present disclosure.

FIG. 2C is a cross sectional explanatory diagram schematically representing a process for joining a ball portion of a CSP with the solder paste of the embodiment of the present disclosure.

FIG. 2D shows an image of a cross section of a CSP solder joint portion bonded with the solder paste of the embodiment of the present disclosure.

FIG. 3A is a cross sectional explanatory diagram schematically representing a process for joining a chip component with the solder paste of the embodiment of the present disclosure.

FIG. 3B is a cross sectional explanatory diagram schematically representing a process for joining a chip component with the solder paste of the embodiment of the present disclosure.

FIG. 3C is a cross sectional explanatory diagram schematically representing a process for joining a chip component with the solder paste of the embodiment of the present disclosure.

FIG. 4 is a table showing the formulations, properties, and overall evaluation results for the solder pastes of Examples 1 to 10 in the Examples of the present disclosure.

FIG. 5 is a table showing the formulations, properties, and overall evaluation results for the solder pastes of Comparative Examples 1 to 3 in the Examples of the present disclosure.

FIG. 6 is a cross sectional view schematically representing a method used to measure shear adhesion of a chip component.

FIG. 7 is a graph representing the results of shear adhesion measurement for chip components of Examples of the present disclosure.

### DESCRIPTION OF EMBODIMENTS

An embodiment of the present disclosure is described below, with reference to the accompanying drawings.

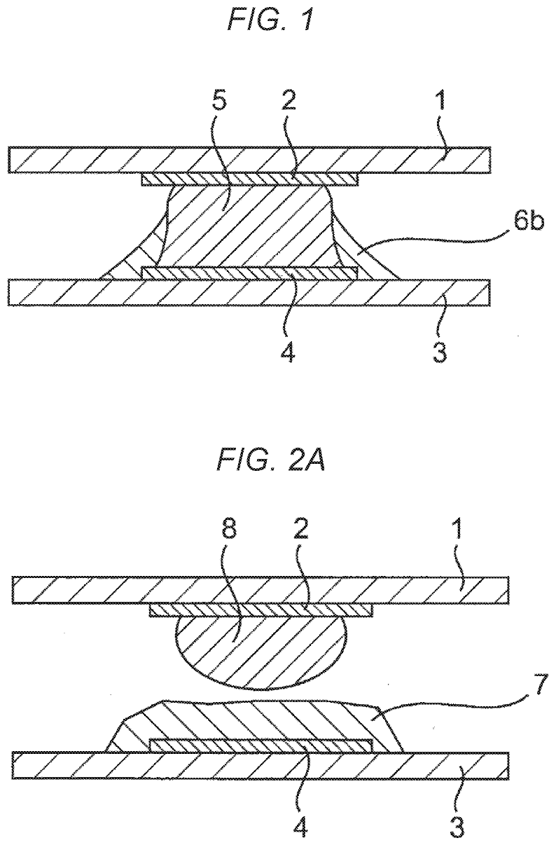

A solder paste of an embodiment of the present disclosure contains a solder powder and a flux. FIG. 1 is a cross sectional view of a solder joint portion of a CSP bonded with the solder paste of the embodiment of the present disclosure. As illustrated in FIG. 1, an electrode 2 provided on a CSP substrate 1, and an electrode 4 provided on a circuit board 3 are metallurgically bonded to each other with a conductive portion 5 configured from a melted portion of a solder ball, and a portion derived from the solder powder. The periphery of the bonded portion is reinforced by a reinforcing portion 6b, which is a flux-derived, cured solid epoxy resin.

The following describes the composition of the solder paste of the embodiment of the present disclosure in detail.

The solder paste of the embodiment of the present disclosure contains a solder powder and a flux, and may contain other components, as required. The flux contains an epoxy resin, a phenolic resin, a benzooxazine compound, and an activating agent.

Flux

The flux in the solder paste of the embodiment of the present disclosure contains an epoxy resin, a phenolic resin, a benzooxazine compound, and an activating agent. The phenolic resin contains at least one type of phenolic resin having a phenolic hydroxyl group and an allyl group within the molecule. With the flux in the solder paste of the embodiment of the present disclosure having a composition with such components, the solder paste is able to effectively show excellent applicability, high adhesion, and excellent solder joint reliability and stable conductivity at the joints.

The flux content is preferably 5 mass % to 95 mass % with respect to the total mass of the solder paste. With a flux content of 5 mass % or more, the solder paste can desirably produce the fluxing effect during the solder bonding process. With a flux content of 95 mass % or less, it is possible to ensure appropriate printability while the remaining solder powder provides stable conductivity at the joints.

The essential components of the flux are described below in greater detail.

### Epoxy Resin

The epoxy resin typically refers to a thermosetting resin that has an epoxy group within its structure, and that can be cured by heat. In the embodiment of the present disclosure, the epoxy resin (base epoxy resin) contained in the flux is an epoxy resin that is liquid at ordinary temperature. By using such an epoxy resin, other components, including solder particles, can be dispersed with ease. As used herein, “liquid at ordinary temperature” means that there is fluidity in a temperature range of 5° C. to 28° C., particularly at a room temperature of about 20° C. under the atmospheric pressure. Alternatively, an epoxy resin that is solid at ordinary temperature may be turned into a liquid by mixing it with a liquid epoxy resin.

The epoxy resin that is liquid at ordinary temperature is not particularly limited in terms of a molecular weight and a molecular structure, and various epoxy resins may be used, provided that the epoxy resin has two or more epoxy groups within the molecule. Examples of such epoxy resins include various liquid epoxy resins, including glycidyl ether, glycidyl amine, glycidyl ester, and olefin oxidized (alicyclic) liquid epoxy resins. Specific examples include bisphenol epoxy resins, such as bisphenol A epoxy resins, and bisphenol F epoxy resins; hydrogenated bisphenol epoxy resins, such as hydrogenated bisphenol A epoxy resins, and hydrogenated bisphenol F epoxy resins; biphenyl epoxy resins, naphthalene ring-containing epoxy resins, alicyclic epoxy resins, dicyclopentadiene epoxy resins, phenol novolac epoxy resins, cresol novolac epoxy resins, triphenylmethane epoxy resins, aliphatic epoxy resins, and triglycidyl isocyanurate. These may be used either alone or in a combination of two or more. In terms of reducing the viscosity of the liquid epoxy resin composition for sealing of semiconductors, and improving the quality of the cured product, preferred as the epoxy resin that is liquid at ordinary temperature are bisphenol epoxy resins, and hydrogenated bisphenol epoxy resins. Specific examples of such epoxy resins include commercially available products such as bisphenol A epoxy resin jER828 (available from Mitsubishi Chemical Corporation), and bisphenol F epoxy resin jER806 (available from Mitsubishi Chemical Corporation).

The content of the epoxy resin in the flux may vary with the phenolic resin and the benzooxazine compound present in the flux, and may be appropriately selected. Specifically, it is important that a predetermined range be satisfied by the ratio of the number of moles of the epoxy group of the epoxy resin, the number of moles of the phenolic hydroxyl group of the phenolic resin, and the number of moles of the dihydrobenzooxazine ring of the benzooxazine compound, as will be described later.

In order to lower the viscosity of the epoxy resin, the flux may preferably contain a reactive diluent (also referred to as “epoxy reactive diluent”), which is a low-molecular-weight epoxy. With a reactive diluent added to the epoxy resin, the viscosity does not become overly high when the solder powder is added in a later step, and ease of handling of the solder paste can improve. A solvent may be added to the epoxy resin to lower the viscosity of the epoxy resin and produce a cream solder paste, which can be handled with more ease after adding the solder powder in a later step. It is, however, preferable to lower the viscosity of the epoxy resin by using a reactive diluent because the reactive diluent, by being reactive, becomes incorporated in the reaction product of the epoxy resin and the curing agent, and does not easily cause void formation in the cured product.

The reactive diluent may be, for example, an alkyl glycidyl ether-based compound, such as butyl glycidyl ether or 2-ethylhexyl glycidyl ether. These alkyl glycidyl ether-based compounds have very low viscosities, and produce a large viscosity-reducing effect. However, these compounds are highly volatile due to their low boiling points. This is problematic because it causes the compounds to vaporize under the heat of curing. Another problem is that, because these compounds are monofunctional, the crosslink density tends to increase, and it is difficult to ensure rigidity in the cured product. Increase of moisture absorptivity is also a problem. These should be taken into account when using alkyl glycidyl ether-based compounds.

For reasons related to manufacture, many reactive diluents typically contain large amounts of chlorine ions. Halogen ions, such as chlorine ions, cause increase of leak current in electric and electronic components. The chlorine in a reactive diluent ionizes in response to entry of moisture, and causes leak defects and corrosion in electric and electronic components. Against these problems, it is important to reduce the amount of chlorine ions in the reactive diluent.

Considering these, the reactive diluent may be selected from, for example, 1,3-bis[(2,3-epoxypropyl)oxy]benzene, dicyclopentadienedimethanol diglycidyl ether, and N,N-bis(2,3-epoxypropyl)-4-(2,3-epoxypropoxy)aniline. More than one of these compounds may be used in combination. Preferably, the reactive diluent is 1,3-bis[(2,3-epoxypropyl)oxy]benzene.

1,3-bis[(2,3-epoxypropyl)oxy]benzene (represented by the structural formula in chemical formula 1 below) has a structure with two epoxy groups at either terminal of the stable benzene ring skeleton. As an example, the properties of a reactive diluent of essentially 1,3-bis[(2,3-epoxypropyl)oxy]benzene were measured with EX-201-IM available from Nagase ChemteX Corporation. The viscosity was 400 mPa·s, and the total chlorine content was 0.04 mass %. Because 1,3-bis[(2,3-epoxypropyl)oxy]benzene has a rigid benzene ring, an epoxy cured product using 1,3-bis[(2,3-epoxypropyl)oxy]benzene as reactive diluent should have strong room-temperature adhesion, and low moisture absorption.

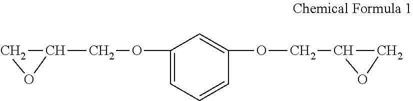 [SMILES: c1cc(OCC2CO2)cc(OCC2CO2)c1]

### Phenolic Resin

The phenolic resin contained in the flux contains at least one type of phenolic resin having a phenolic hydroxyl group and an allyl group within the molecule. Specifically, the phenolic resin is preferably one having two or more phenolic hydroxyl groups capable of reacting with the epoxy group of the epoxy resin, per molecule.

With such a phenolic resin contained in the flux, it is possible to lower the viscosity of the flux, and to make handling of the solder paste even easier after the solder powder is added in a later step. The viscosity lowering effect is probably due to the allyl group of the phenolic resin, which is solid in its standard state, sterically hindering the hydrogen bonding aligning the phenolic hydroxyl groups.

Particularly preferred as such a phenolic resin is one existing as a low-molecular-weight dimer (having the structural formula represented by the chemical formula 2 below, n=0)) because such a phenolic resin takes a more preferred, liquid form by being contained in the flux, and can desirably lower the viscosity of the solder paste. Specific examples of such phenolic resins include commercially available products such as phenolic resin MEH8000H (a viscosity of 1,500 Pa·s to 3,500 mPa·s, a hydroxyl group equivalent of 139 to 143), and phenolic resin MEH8005 (a viscosity of 4,500 Pa·s to 7,500 mPa·s, a hydroxyl group equivalent of 133 to 138), both available from Meiwa Plastic Industries.

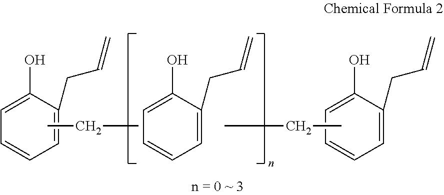

A phenolic resin having no allyl group may be used with a phenolic resin having an allyl group. As described above, a phenolic resin having an allyl group produces a viscosity lowering effect probably by the steric hindrance due to the allyl group. Similarly, the steric hindrance due to the allyl group also tends to slow the reaction between the phenolic hydroxyl group and the epoxy group, and makes it difficult to increase crosslink density. It is accordingly possible to increase the reactivity with the epoxy group by using a phenolic resin having no allyl group with a phenolic resin having an allyl group. With increased reactivity for the epoxy group and increased crosslink density, the cured product can increase its strength, and the solder paste can increase its adhesiveness. However, because the solder paste also increases its viscosity, it is required to appropriately adjust the amount of the phenolic resin having no allyl group, and the amount of the phenolic resin having an allyl group.

Specifically, the phenolic resin contains preferably 40 mass % or less of a phenolic resin having no allyl group with respect to the total amount of phenolic resin. By containing a phenolic resin having no allyl group in an amount of 40 mass % or less, it is possible to prevent the viscosity of the solder paste from being overly increased.

The phenolic resin having no allyl group is not particularly limited, as long as two or more phenolic hydroxyl groups capable of reacting with the epoxy resin are contained within the molecule. For example, the phenolic resin having no allyl group is preferably a multifunctional phenol having two or more phenolic hydroxyl groups within the molecule, such as bisphenol A, phenol novolac, or cresol novolac. In order for the two or more phenolic hydroxyl groups present in the molecule to be more soluble in other components such as the epoxy resin, the phenolic resin has a softening point of preferably 60° C. to 110° C., and a hydroxyl group equivalent of 70 g/eq to 150 g/eq. In the present disclosure, “softening point” refers to a temperature at which the phenolic resin softens, and starts to deform as a result of temperature increase, and that is measured by using the ring and ball method of measuring softening point. In the present disclosure, “hydroxyl group equivalent” refers to a numerical value measured by a neutralization titration method in compliance with JIS K 0070. Specific examples of the phenolic resin having no allyl group include commercially available products such as phenol novolac resin H-4, phenol aralkyl resin MEH-7800, and biphenyl aralkyl resin MEH-7851SS (these are all available from Meiwa Plastic Industries, Ltd.). A phenolic resin having only one phenolic hydroxyl group within the molecule also may be used with the phenolic resin having no allyl group.

The content of the phenolic resin in the flux (the total amount of the phenolic resin having an allyl group, and the phenolic resin having no allyl group) may vary with the epoxy resin and the benzooxazine compound present in the flux, and may be appropriately selected. Specifically, it is important that a predetermined range be satisfied by the ratio of the number of moles of the epoxy group of the epoxy resin, the number of moles of the phenolic hydroxyl group of the phenolic resin, and the number of moles of the dihydrobenzooxazine ring of the benzooxazine compound, as will be described later.

### Benzooxazine Compound

The benzooxazine compound is not particularly limited, as long as it contains a dihydrobenzooxazine ring having a benzene skeleton and an oxazine skeleton (a ring having a structure that has N and O within the same ring of the oxazine skeleton, and that can be understood as having one of the double bonds of the oxazine hydrogenated with two atoms of hydrogen, and the other double bond forming a side of the benzene skeleton; the dihydrobenzooxazine ring is also called simply as “benzooxazine ring”).

In a normal state, the dihydrobenzooxazine ring of the benzooxazine compound is chemically stable, and chemical reaction does not proceed. When heated to about 170° C. or higher, the dihydrobenzooxazine ring opens, and the benzooxazine compound transforms into a polybenzooxazine compound having a diaminodiphenyl structure formed of a phenolic hydroxyl group and a basic amino group. The basic amino group present in the diaminodiphenyl structure formed by opening of the ring appears to promote a high-temperature reaction between the epoxy resin and the phenolic resin at a temperature equal to or greater than the melting point of the solder powder (for example, about 219° C. in the case of SAC solder), and serve as a curing promoting agent to accelerate curing of the resin following melting of the solder. The dihydrobenzooxazine ring of the benzooxazine compound does not open below 170° C. Accordingly, the reaction between the epoxy resin and the phenolic resin does take place under this temperature, and melting and agglomeration of the solder will not be inhibited, as will be described later. Once the ring opens, the phenolic hydroxyl group is able to self-polymerize without producing a by-product, and react with the epoxy resin or other components. In this manner, opening of the dihydrobenzooxazine ring following melting of the solder is followed by a rapid flux reaction.

For example, JP-A-2000-248151 and JP-A-2002-047391 disclose a technique in which a curing promoting agent and a phenolic resin are added to, for example, a composition of primarily a benzooxazine compound and an epoxy resin to lower the resin reaction temperature to a low temperature region of about 150° C. or less. If this technique were applied to the solder paste of the present embodiment, the resin, with the lowered curing temperature, would thicken before it reaches the high melting point, with the result that the melting and agglomeration of the solder is inhibited, as will be described later. The solder paste of the embodiment of the present disclosure, however, contains the benzooxazine compound (and the activating agent) in appropriate amounts, in addition to the epoxy resin and the phenolic resin contained as main components, and enables desirable solder connections to be made without thickening before reaching the high melting point.

In order to further improve its functionality as a curing promoting agent, the benzooxazine compound is preferably a polyvalent oxazine having a plurality of dihydrobenzooxazine rings within the molecule.

The content of the benzooxazine compound in the flux varies with the epoxy resin and the phenolic resin present in the flux, and may be appropriately selected. Specifically, it is important that a predetermined range be satisfied by the ratio of the number of moles of the epoxy group of the epoxy resin, the number of moles of the phenolic hydroxyl group of the phenolic resin, and the number of moles of the dihydrobenzooxazine ring of the benzooxazine compound, as will be described later.

The structure of the benzooxazine compound depends on the type of the raw material used. In the present disclosure, benzooxazine compounds synthesized from various raw materials may be used. It is also possible to use commercially available benzooxazine compounds.

A typical example of commercially available benzooxazine compounds is a P-d type benzooxazine compound (a polymerization product of phenol, diaminodiphenylmethane, and formaldehyde; available from Shikoku Chemicals Corporation).

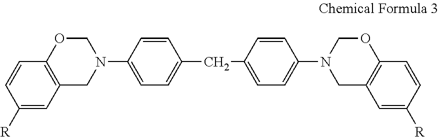

In the formula, R represents hydrogen or an allyl group.

Another example of commercially available benzooxazine compounds is an F-a type benzooxazine compound having a different resin skeleton (a polymerization product of bisphenol F, aniline, and formaldehyde; available from Shikoku Chemicals Corporation).

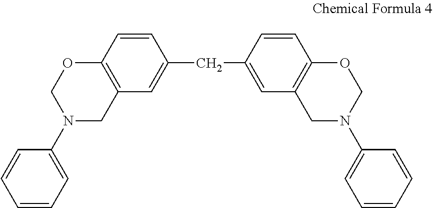 [SMILES: c1ccc(N2COc3ccc(Cc4ccc5c(c4)CN(c4ccccc4)CO5)cc3C2)cc1]

As described above, the flux contains the benzooxazine compound, in addition to the epoxy resin (containing a low-molecular-weight epoxy reactive diluent, as required) and the phenolic resin contained as main resin components. As described above, the polybenzooxazine formed by opening of the dihydrobenzooxazine ring of the benzooxazine compound acts to promote curing of the epoxy resin and the phenolic resin. It has been found that the reaction of these compounds desirably takes place when the ratio of the number of moles of the epoxy group of the epoxy resin, the number of moles of the phenolic hydroxyl group of the phenolic resin, and the number of moles of the dihydrobenzooxazine ring of the benzooxazine compound contained in the flux is preferably 100:50 to 124:6 to 50 (number of moles of epoxy group:number of moles of phenolic hydroxyl group:number of moles of dihydrobenzooxazine ring).

As used herein, “number of moles” is calculated as (mass of each component in the solder paste)/(molecular weight/number of functional groups). The ratio is calculated by using the calculated number of moles, relative to the number of moles of the epoxy group taken as 100.

When the number of moles of the phenolic hydroxyl group is 50 or more relative to the number of moles of the epoxy group at 100, the epoxy group does not exist in excess amounts, and there is no remaining epoxy group after the reaction. Accordingly, crosslinking desirably proceeds to form a cured product, and produces a large reinforcing effect. When the number of moles of the phenolic hydroxyl group is 124 or less relative to the number of moles of the epoxy group at 100, the phenolic hydroxyl group does not exist in excess, and is prevented from turning into a plasticizer. Accordingly, crosslinking desirably proceeds to form a cured product, and produces a large reinforcing effect. When the number of moles of the dihydrobenzooxazine ring is 6 or more relative to the number of moles of the epoxy group at 100, the effect to promote curing of the epoxy resin and the phenolic resin does not weaken. Accordingly, crosslinking desirably proceeds to form a cured product, and produces a large reinforcing effect. When the number of moles of the dihydrobenzooxazine ring is 50 or less relative to the number of moles of the epoxy group at 100, the curing promoting effect does not become overly high, and the resin does not thicken before melting and agglomeration of solder takes place. The ratio of numbers of moles is more preferably 100:60 to 100:7 to 40, even more preferably 100:70 to 90:7 to 30.

Upon converting the balanced ratio of numbers of moles, it is preferable that the number of moles of the epoxy group, and the sum of the number of moles of the phenolic hydroxyl group and the number of moles of the dihydrobenzooxazine ring satisfy 0.5 to 1.3 ({(number of moles of phenolic hydroxyl group)+(number of moles of dihydrobenzooxazine ring)}/(number of moles of epoxy group)).

### Activating Agent

The activating agent may be any appropriately selected activating agent, and the type of activating agent is not limited, as long as it serves to remove the metal oxide film. For example, the activating agent may be an organic acid, a halogen, or an amine salt having the reducing power to remove an oxide film that may be present on an adherend such as an electrode of an electronic component, wires, and/or the surface of the solder powder, in a temperature region in which the solder paste is heated. Considering impairment of insulation of the cured product of epoxy resin due to halogen, and impairment of preservation stability of the paste due to amine salts, the activating agent is preferably an organic acid for its desirable property against deterioration of insulation. Organic acids are particularly preferred for electric and electronic applications. Among amine-base activating agents, triethanolamine (TEA) is preferred for its desirable reactivity and preservability.

Organic acids have a desirable fluxing effect (as used herein, “fluxing effect” means the reducing effect that removes the oxide coating that has occurred on the metal surface to which the solder paste is applied, and the effect that lowers the surface tension of a molten solder to promote solder wettability for the soldered metal surface). In terms of reactivity to the epoxy resin, organic acids are preferred for their high reactivity exhibited during heating, though the reactivity is not as high as that of amine salts at room temperature. Organic acids also cause hardly any harmful effects, such as corrosiveness, because organic acids become incorporated in the cured product of the epoxy resin after the solder is reduced and the oxide film is removed.

The type of organic acid is not particularly limited, and the organic acid may be an acid of any organic compound. Examples include materials of rosin components, such as abietic acid; amines and salts thereof; sebacic acid, adipic acid, glutaric acid, succinic acid, malonic acid, citric acid, and pimelic acid. Considering reaction with the epoxy resin, preferred as the organic acid is a dibasic acid, which does not cause decrease of crosslink density.

The organic acid reacts with the epoxy group at its carboxyl group, even at a temperature of 200° C. or less, and participates in thickening of the flux in the solder paste. For this reason, the organic acid, when used as an activating agent, should have a melting point of preferably 130° C. to 220° C., more preferably 130° C. to 200° C., even more preferably 133° C. to 186° C. This is because the below mentioned melting and agglomeration of solder is less likely to be inhibited with a dibasic organic acid having a high melting point.

Specifically, it is preferable that the organic acid show only small activity (the reducing effect to remove an oxide film on a solder surface) in a low-temperature region of 130° C. or less against a solder having a high melting point, for example, such as a SAC solder, and develop its activity against such solders in a high-temperature region. Examples of organic acids having a melting point of 130° C. to 220° C. include succinic acid (melting point 186° C.), adipic acid (melting point 152° C.), suberic acid (melting point 142° C.), and sebacic acid (melting point 133° C.), which are all dibasic acids. Anhydrous oxalic acid has a high melting point of 189° C. However, with its high hygroscopicity, this acid transforms into the dihydrous form having a lower melting point (melting point 101° C.) by absorbing moisture. An organic acid, for example, isophthalic acid (melting point 340° C.), having a higher melting point than SAC solders typically cannot be expected to act as an organic acid that removes an oxide film on the solder. However, such organic acids having a melting point of less than 130° C. or a melting point of more than 220° C. are not intended to be excluded from the organic acids that are usable in the present disclosure, and these organic acids may be used as appropriate, depending on conditions such as the type of the solder, and the reflow temperature used. These organic acids may be used as a single component, or as a mixture of two or more components.

The activating agent is contained in a proportion of preferably 0.05 mass % to 60 mass %, more preferably 0.1 mass % to 50 mass %, even more preferably 0.2 mass % to 30 mass % with respect to the total mass of the flux. With the content of the activating agent (particularly the organic acid) falling in these ranges, the fluxing effect can be appropriately produced, and desirable joint reliability can be obtained.

### Other Components

The solder paste may contain other components, for example, such as common modifying agents (for example, rosin) and additives. For the purpose of reducing viscosity and imparting fluidity to the solder paste, a low-boiling-point solvent or a diluent may be added. It is also effective to add, for example, hydrogenated castor oil or stearamide as a thixotropy imparting agent for maintaining the printed shape.

### Solder Powder

The solder powder contained in the solder paste of the embodiment of the present disclosure is not particularly limited, and is preferably a solder powder having a melting point of 180° C. or more, particularly 200° C. or more. The composition of the solder powder is not particularly limited, and may be in the form of a solder alloy. For example, a Sn-base alloy of SAC solder, Sn—Cu-base solder, or Sn—Ag-base solder may be used. Examples of the SAC solder include a SAC305 (Sn-3.0Ag-0.5Cu) solder having a melting point of 219° C., a SAC405 (Sn-4.0Ag-0.05Cu) solder having a melting point of 220° C., and a SAC105 (Sn-1.0Ag-0.5Cu) solder having a melting point of 225° C. Examples of the Sn—Ag-base solder include a Sn-3.5Ag solder having a melting point of 221° C. Examples of the Sn—Cu-base solder include a Sn-0.7Cu solder having a melting point of 227° C. Preferred among these solder alloys is SAC305 solder. SAC305 solder is preferred because it is already commonly used in consumer electronic devices, and, with its high joint reliability and low cost, has found use in a wide range of solder ball applications for CSP and BGA packages.

The content of the solder powder is preferably 5 mass % to 95 mass % with respect to the total mass of the solder paste. With a solder powder content of 5 mass % or more, sufficient connections can be ensured. With a solder powder content of 95 mass % or less, the viscosity does not turn overly high, and the level of viscosity appropriate as a paste can be ensured while providing enough flux component, making it possible to produce an appropriate reinforcing effect. The solder powder content is more preferably 40 mass % to 95 mass %, even more preferably 50 mass % to 95 mass %. With the solder powder content falling in these ranges, the paste can effectively accomplish high joint reliability and desirable printability at the same time.

When the solder paste is to be used to join a SAC solder ball to an electrode of a circuit board, the content of the solder powder with respect to the total mass of the solder paste is preferably 5 mass % to 60 mass %. In this type of connection, the metal joints are made primarily by the SAC solder ball, and the metal in the solder paste helps the metallic bonding of the solder ball. With the solder powder content falling in the foregoing ranges, the proportion of the resin in the solder paste increases, and the resin is able to effectively reinforce the periphery of the solder joint portion, making it possible to strengthen the connection. With a solder powder content of 60 mass % to 95 mass %, the proportion of the metal in the solder paste increases, and the metallic component in the solder paste alone is able to form a sufficient metal connection, allowing the solder paste to be used with or without using a SAC solder ball (for example, BGA type in the case of the former, and LGA type in the case of the latter).

In describing the composition of the solder powder in this specification, the symbols of the elements contained in the solder powder are linked by hyphens. In the metal composition of the solder powder described herein, the metallic elements are often preceded by numerical values or numerical ranges. These numerical values or numerical ranges represent the fraction of each element of the metal composition in mass % (=mass %), as commonly used in the art. The solder powder may contain trace amounts of incidental metals, for example, such as Ni, Ge, Zn, Sb, and Cu, provided that the solder powder is configured substantially from the elements shown.

In the specification, the melting point of the solder powder (or the solder) is the temperature after the solder powder has melted in an observation of state changes of a sample under the applied heat of increasing temperatures, and may be measured using, for example, DSC or TG-DTA.

The following describes a method for preparing the solder paste of the embodiment of the present disclosure, and a specific exemplary method for producing (or manufacturing) amount structure by mounting an electronic component on a circuit board using the solder paste.

First, the flux is produced by weighing and mixing the epoxy resin, the phenolic resin, the benzooxazine compound, and the activating agent. The solder powder is then added to the flux, and mixed and kneaded.

A semiconductor component can be mounted on, for example, a circuit board having conductive wires, using the solder paste of the embodiment of the present disclosure. The mount structure of the embodiment of the present disclosure, for example, a semiconductor device, has a joint portion where the terminal of the semiconductor component and the electrode of the circuit board are bonded to each other with the solder paste. The solder paste can be applied as follows, for example. A metal mask having through holes corresponding in position to the electrodes is laid over the circuit board. The solder paste is then applied to the surface of the metal mask, and the through holes are filled with the solder paste using a squeegee. Removing the metal mask from the circuit board results in the solder paste being applied to each electrode on the circuit board.

While the solder paste is in an uncured state, a chip component or a semiconductor component is stacked on the circuit board with the terminal of the chip component or the semiconductor component facing the electrode of the circuit board, using a tool such as a chip mounter. Here, the chip component may be, for example, a chip resistor or a chip capacitor. The semiconductor component may be, for example, a CSP or BGA semiconductor package having a solder ball as the terminal, or a QFP semiconductor package provided with a lead terminal. The semiconductor component also may be a semiconductor device (bare chip) provided with a terminal without being housed in a package.

In this state, the printed wiring board with the chip component is heated to a predetermined heating temperature with a reflow furnace. In this way, a semiconductor device of an embodiment of the present disclosure is produced that has a conductive portion where the terminal of the chip component or semiconductor component and the electrode of the circuit board are connected to each other via the solder paste of the embodiment of the present disclosure. The conductive portion includes a solder joint portion (conductive portion) where the solder powder and the solder ball have melted and integrated, and a cured epoxy resin portion (reinforcing portion) where the cured product of the flux covers the periphery of the conductive portion. In this manner, the solder paste of the embodiment of the present disclosure can be used to produce a mount structure in which a component and a substrate are electrically bonded to each other with the conductive portion, and the reinforcing portion provides mechanical reinforcement.

The reflow step needs to ensure that the solder powder sufficiently melts, and that the curing reaction of the resin component in the flux takes place both sufficiently and appropriately. Specifically, in the reflow step, the flux thickens if the curing reaction of the epoxy resin contained as a flux component in the solder paste proceeds before the solder powder completely melts. This inhibits agglomeration and melting of the solder particles, with the result that appropriate metal conduction cannot be provided. To avoid this, it is required to set the reflow furnace temperature so that the curing reaction of the resin proceeds slowly until the temperature reaches the melting point of the solder powder used, and that the curing reaction of the flux resin proceed to completion in a short time period (for example, in about several minutes) after the solder powder has melted, and, for example, bonded to the electrode metal of a circuit component by fusing with the solder ball of a semiconductor component.

In the solder paste of the embodiment of the present disclosure, the flux composition contains appropriate amounts of benzooxazine compound (and activating agent), in addition to the epoxy resin and the phenolic resin contained as main components. Accordingly, the flux does not easily thicken while the reflow furnace temperature is rising to the melting point of the solder powder in the solder paste (specifically, to the melting point of common SAC305 solder at about 219° C.). With an appropriate amount of activating agent additionally contained in the flux composition, the solder is able to desirably melt, and the resin flux can quickly cure after the solder has melted.

In another embodiment, the reflow furnace may have a two-step profile whereby the temperature is lowered to 150 to 200° C. after melting the solder, in order to enable milder curing. In this case, the curing rate slows down when the benzooxazine compound formed by opening of the ring, and the activating agent are used alone, and an appropriate amount of curing promoting agent may be added to such an extent that it does not inhibit melting of the solder. Examples of the curing promoting agent include cyclic amines such as imidazoles, tertiary amines, and DBU salts; triarylphosphines such as TPP salts; quaternary phosphonium salts; and metal complexes such as iron acetylacetonate. Preferred are those of a high-temperature reaction system.

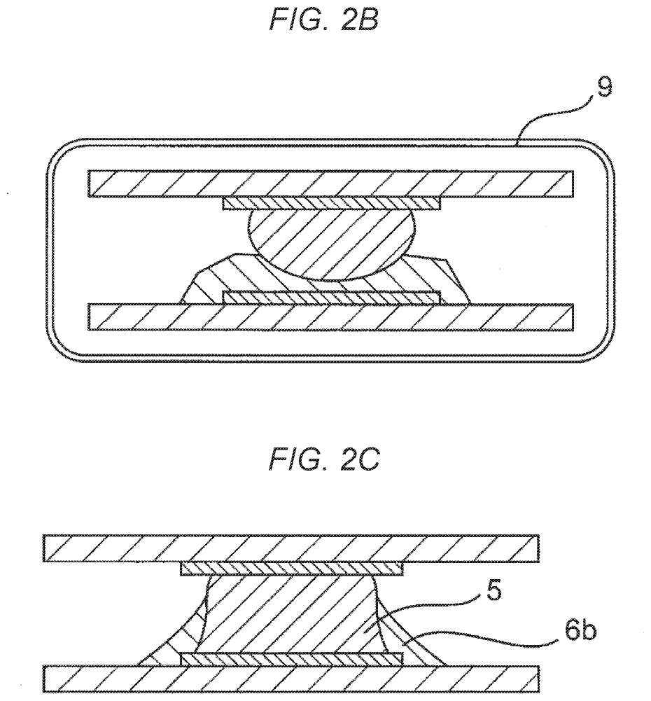

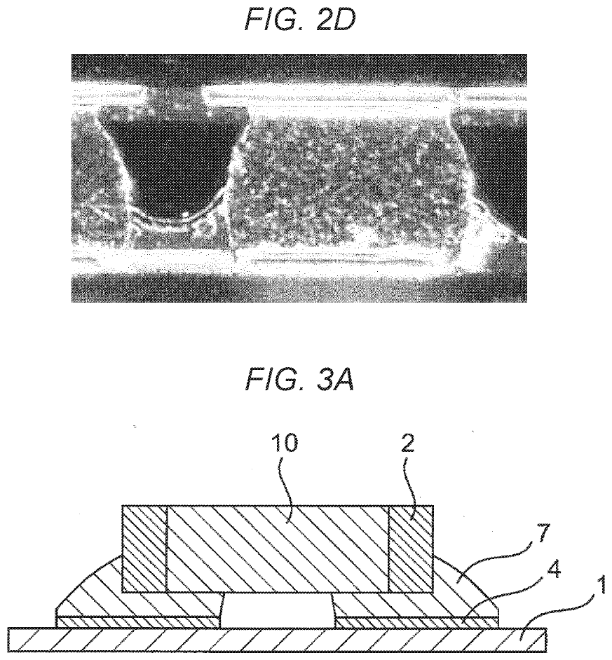

FIGS. 2A to 2C are cross sectional explanatory diagrams schematically representing processes for joining a ball portion of a CSP with the solder paste of the embodiment of the present disclosure. As illustrated in FIGS. 2A to 2C, an electrode 2 provided on a CSP substrate 1, and an electrode 4 provided on a circuit board 3 are bonded to each other with a solder ball 8 and a solder paste 7, and the assembly is heat cured with a drier 9 to complete the bond. In the resulting structure, the periphery of the conductive portion 5 is reinforced by the reinforcing portion 6b, a cured solid epoxy resin. FIG. 2D shows an image of a cross section of a CSP solder joint portion bonded with the solder paste of the embodiment of the present disclosure. As described above, the periphery of the conductive portion 5 has a structure reinforced by the reinforcing portion 6b formed by the cured resin.

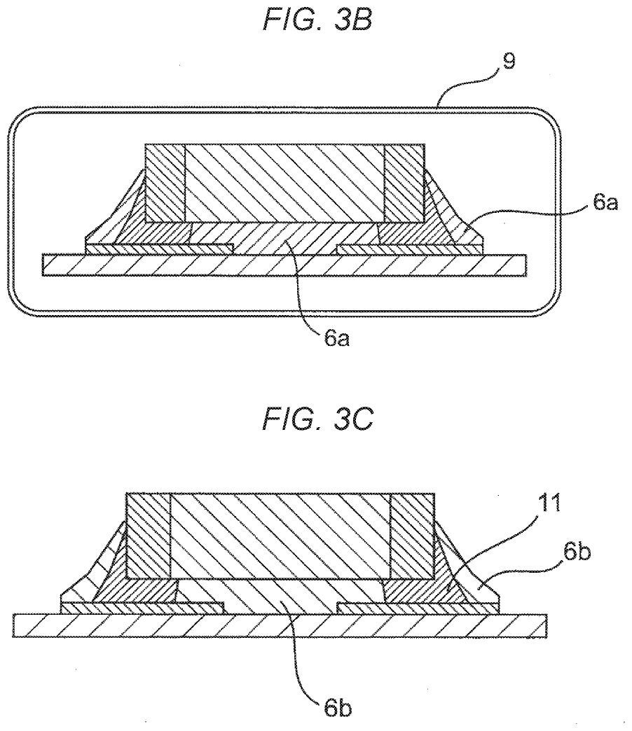

FIGS. 3A to 3C are cross sectional explanatory diagrams schematically representing processes for bonding a chip component with the solder paste of the embodiment of the present disclosure. As illustrated in FIGS. 3A to 3C, a chip component 10 is mounted on the solder paste 7 applied on an electrode 4 provided on the circuit board 3, and the assembly is heat cured with the drier 9. This causes the solder to melt, and form the conductive portion 11. The pressure of the agglomerated solder pushes out the liquid epoxy resin 6a, and forms a structure in which the epoxy resin covers the periphery of the solder, and/or the bottom of the chip component 10. By subsequent heating, the epoxy resin cures into the reinforcing portion 6b, a solid epoxy resin. This completes the production of the mount structure having the conductive portion 11 formed by metal bonding of the chip component 10 and the circuit board 3 (a metallic bond containing the metal derived from the solder powder in the raw material solder paste), and the reinforcing portion 6b surrounding the conductive portion 11.

### EXAMPLES

The following describes Examples and Comparative Examples of the present disclosure. It is to be noted that the forms of the Examples and Comparative Examples of the present disclosure below are merely illustrative, and are not intended to limit the present disclosure in any ways. In the following Examples and Comparative Examples, “parts” and “%” are by mass, unless otherwise specifically stated.

### Production of Solder Paste

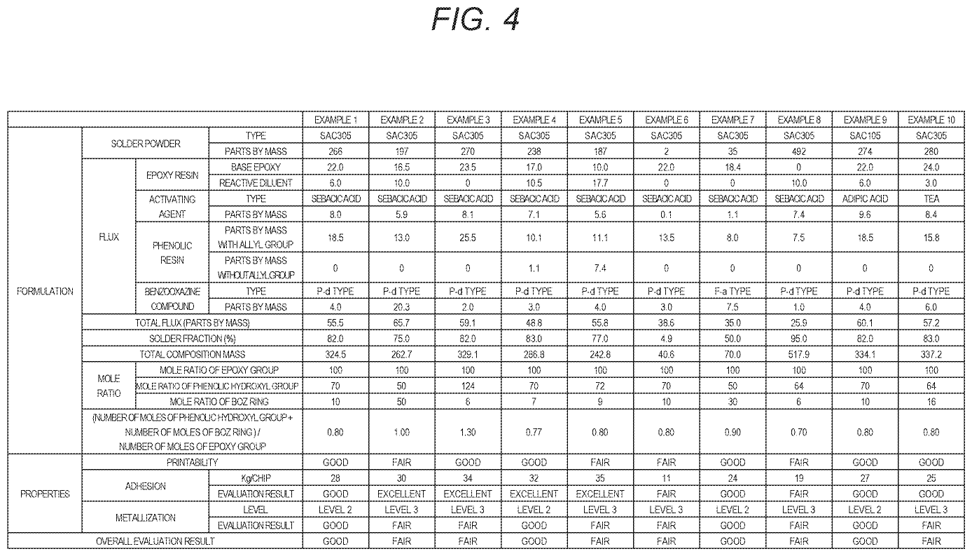

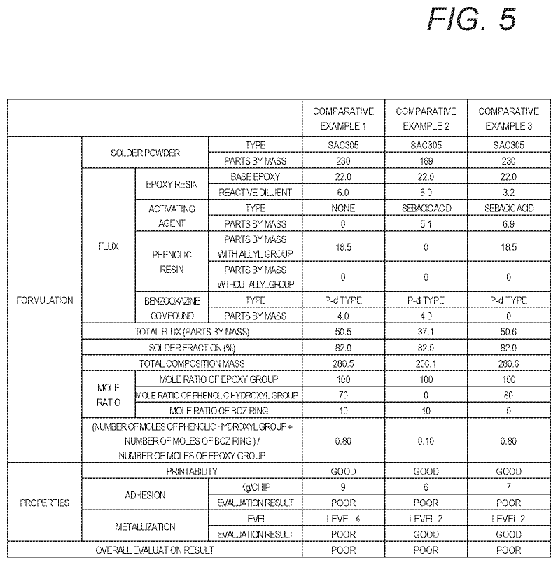

An epoxy resin, a phenolic resin, and a benzooxazine compound were weighed in the proportions (parts by mass) shown in FIGS. 4 and 5, and heated to 140° C. to melt into a homogenous resin mixture. After cooling the mixture to room temperature, a weighed amount of organic acid was added into the mixture, and mixed with a planetary mixer to produce fluxes of Examples 1 to 10 and Comparative Examples 1 to 3.

A bisphenol F epoxy resin jER806 (available from Mitsubishi Chemical Corporation) was used as the epoxy resin. As the epoxy reactive diluent, 1,3-bis[(2,3-epoxypropyl)oxy]benzene (EX-201-IM available from Nagase ChemteX Corporation; the structural formula is represented by the Chemical Formula 1 above) was used. An allyl-modified phenol novolacMEH8000H (available from Meiwa Plastic Industries, Ltd.) was used as the phenolic resin. As a general-purpose phenol novolac, a phenol novolac HF-1M or H-4 (available from Meiwa Plastic Industries, Ltd.) was used. A P-d or F-a type benzooxazine (available from Shikoku Chemicals Corporation) was used as the benzooxazine compound. Sebacic acid, adipic acid, or triethanolamine (TEA) (all available from. Tokyo Chemical Industry Co., Ltd.) was used as activating agent.

A solder powder was added to each flux of Examples 1 to 10 and Comparative Examples 1 to 3 in the proportions (parts by mass) shown in FIGS. 4 and 5, and the mixture was kneaded to prepare a solder paste. The solder powder used is a SAC305 solder powder (Sn-3.0Ag-0.5Cu; average particle diameter: 10 to 25 μm, melting point: 219° C.), or a SAC105 solder powder (Sn-1.0Ag-0.5Cu; average particle diameter: 10 to 25 μm, melting point: 225° C.) (both available from Mitsui Mining & Smelting Co., Ltd.).

### Production of Adhesion Evaluation Device

The solder paste prepared in the manner described above was printed on an Au-plated electrode on a circuit board (FR-4 substrate) in a thickness of 0.1 mm to form a solder paste printed portion, using a metal mask.

A chip resistor (tin electrode) measuring 3.2 mm×1.6 mm in size was then mounted on the solder paste printed portion on the circuit board, using a chip mounter. The circuit board used copper as electrode material, and a glass epoxy material as substrate material. By using a reflow device, the assembly was heated at 240° C. for 6 minutes to form a joint portion, and produce an evaluation device.

### Evaluation

Examples 1 to 10 and Comparative Examples 1 to 3 were evaluated with respect to the following items. The evaluation results for each example and comparative example are presented in FIGS. 4 and 5 as properties of the solder paste.

### Printability

The printability of the solder paste was evaluated by observing the shape of the solder paste printed with a metal mask. In the observation, the solder paste was visually checked for the extent of confinement in the electrode area, and dripping and pointing. The evaluation of printability is based on the transferred shape of the paste on the electrode of the circuit board through the through hole of the mask. The printability is “Good” when the shape was maintained in the electrode portion, “Fair” when the shape was partially disrupted (dripping or pointing, or both) but was usable, and “Poor” when the shape was seriously disrupted.

### Adhesion

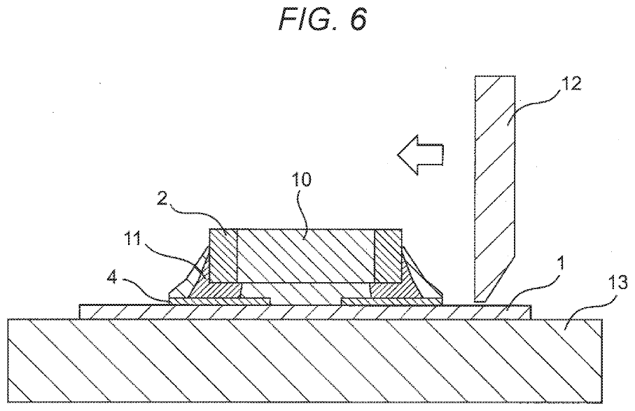

FIG. 6 is a schematic cross sectional view representing the method used to measure the shear adhesion of the chip component. The chip component 10 was fixed on a heatable stage 13, and horizontally pushed with a shear jig 12 to measure adhesion strength. The adhesion of the solder paste was evaluated by measuring the shear adhesion of the adhesion evaluation device above at room temperature (20° C.) using a Series 4000 bond tester available from DAGE. In the evaluation of adhesion, the evaluation result is “Excellent” when the joint portion remained undamaged even under an applied load of more than 30 kg/chip, “Good” when the joint portion was damaged under an applied load of 20 to 30 kg/chip, “Fair” when the joint portion was damaged under an applied load of 10 to 20 kg/chip, and “Poor” when the joint portion was damaged under an applied load of less than 10 kg/chip.

### Metallization

Metallization (solder joint reliability) was evaluated in compliance with the JIS Z3284-4 solder ball test, as follows. The evaluation result is “Excellent” when the extent of solder agglomeration was level 1, “Good” when the extent of solder agglomeration was level 2, “Fair” when the extent of solder agglomeration was level 3, and “Poor” when the extent of solder agglomeration was level 4. The extent of solder agglomeration was categorized into different levels according to the following criteria.

Level 1: Solder (powder) melted, and formed a single large ball with no other solder ball around.

Level 2: Solder (powder) melted, and formed a single large ball with at most three other solder balls around (each having a diameter of 75 μm or less)

Level 3: Solder (powder) melted, and formed a single large ball with at least four other solder balls around (each having a diameter of 75 μm or less). The solder balls did not occur in a semi-continuous annular pattern.

Level 4: Solder (powder) melted, and formed a single large ball with a large number of fine balls around. The solder balls occurred in a semi-continuous annular pattern.

### Overall Evaluation

The overall evaluation result is “Good” when the evaluation results for printability, adhesion, and metallization were all “Good”. The overall evaluation result is “Fair” when any one of these properties was “Fair”, and “Poor” when any one of these properties was “Poor”.

In FIGS. 4 and 5, the contents are parts by mass. BOZ ring means dihydrobenzooxazine ring.

To take Example 1 as an example, a SAC305 solder was used as solder powder, as shown in FIG. 4. The solder powder was 266 parts by mass, flux 55.5 parts by mass, and the solder fraction 82.0%. The epoxy resin in the flux is jER806, which was added in an amount of 22.0 parts by mass. The reactive diluent, EX-201-IM, was added in an amount of 6.0 parts by mass. The phenolic resin, MEH8000H, was added in an amount of 18.5 parts by mass. The benzooxazine compound, a P-d type benzooxazine compound, was added in an amount of 4.0 parts by mass. The activating agent, sebacic acid, was added in an amount of 8.0 parts by mass.

In Example 1, the epoxy equivalent of jER806 (molecular weight/number of functional groups) is 160, and accordingly the number of moles of the epoxy group in the epoxy resin is 0.14 moles. Similarly, the epoxy equivalent of reactive diluent (epoxy reactive diluent) (molecular weight/number of functional groups) is 120, and the number of moles of the epoxy group is 0.05 moles. It follows from this that the total number of moles of the epoxy group is 0.19 moles. By similar calculations, the number of moles of the phenolic hydroxyl group of the phenolic resin is 0.13 moles. The number of moles of the dihydrobenzooxazine ring of the benzooxazine resin is 0.02 moles. By taking the number of moles of the epoxy group as 100, the ratio of the number of moles of the epoxy group, the number of moles of the phenolic hydroxyl group, and the number of moles of the dihydrobenzooxazine ring is 100:70:10 in their converted values ((number of moles of epoxy group:number of moles of phenolic hydroxyl group:number of moles of dihydrobenzooxazine ring)=the ratio of the number of moles of phenolic hydroxyl group and number of moles of dihydrobenzooxazine ring).

The solder paste of Example 1 was evaluated to be desirable (Good) for printability. The adhesion was 28 Kg/chip, and was also desirable (Good). The metallization was level 2, yielding a desirable result (Good). Accordingly, the overall evaluation result was Good. The printability, adhesion, and metallization were also determined to be desirable or usable in the solder pastes of Examples 2 to 10, which contained different solder powders, epoxy resins, phenolic resins (containing MEH8000H having an allyl group; an essential component), benzooxazine compounds, and organic acids in different amounts, as shown in FIG. 4.

Comparative Example 1 used a solder paste containing no activating agent. The evaluation result was desirable for printability. However, the solder did not melt, and the metallization was level 4, resulting in “Poor”. The resin was able to cure; however, the metallic bond lacked the required strength, and the adhesion was weak at 9 Kg/chip, resulting in “Poor”. Accordingly, the overall evaluation result was “Poor”.

Comparative Example 2 used a solder paste containing no phenolic resin. The evaluation result was desirable for printability. However, the adhesion was weak, and the evaluation result was “Poor”. Accordingly, the overall evaluation result was “Poor”. This result is due to the absence of the curing agent phenolic resin reacting with the epoxy resin. However, the observed adhesion, though weak, is probably due to the benzooxazine compound reacting with the epoxy resin to some extent.

Comparative Example 3 used a solder paste containing no benzooxazine compound. The evaluation result was desirable for printability. However, the adhesion was weak, and the evaluation result was “Poor”. Accordingly, the overall evaluation result was “Poor”. This is probably the result of the absence of the benzooxazine compound promoting a reaction between the epoxy resin and the phenolic resin, making the curing unable to proceed.

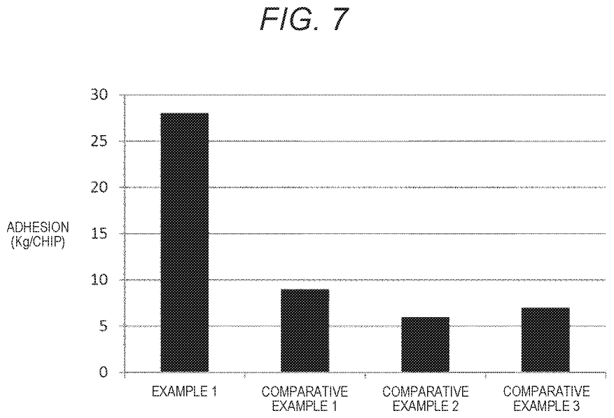

FIG. 7 is a graph representing the results of shear adhesion measurement conducted for chip components in Examples of the present disclosure. As shown in FIG. 7, it can be seen from the comparison of Example 1 and Comparative Examples 1 to 3 that containing at least the epoxy resin, the phenolic resin, the benzooxazine compound, and the activating agent, and the phenolic resin containing a phenolic resin having a phenolic hydroxyl group and an allyl group within the molecule is important for adhesion in a solder paste containing a solder powder and a flux.

The following discuss the results presented in FIGS. 4 and 5. The solder pastes containing the epoxy resin and the phenolic resin as primary flux components show excellent adhesion after a 240° C. reflow process when the benzooxazine compound is additionally added to the solder paste as appropriate. This is probably the result of the benzooxazine compound transforming into a polybenzooxazine compound having a diaminodiphenyl structure after opening of the dihydrobenzooxazine ring under the applied heat of 170° C. or more, and the basic amino group in the diaminodiphenyl structure formed by opening of the ring promoting a reaction between the epoxy resin and the phenolic resin. The hydroxyl group of the phenolic resin itself also appears to react with the epoxy resin to form a cross-linked structure, and provide excellent adhesion.

Because the transformation into the polybenzooxazine compound occurs after the melting of the SAC solder under the foregoing reflow conditions, the flux does not easily thicken before melting of the SAC solder takes place. This will probably produce a very favorable result in melting and bonding of the solder. The dihydrobenzooxazine ring of the benzooxazine compound hardly opens at low temperature, and the solder paste has very stable room-temperature preservability, making it usable for extended time periods at room temperature.

The observed low room-temperature viscosity, and the associated slow curing rate that produced the desirable meltability in the solder containing at least one type of phenolic resin having a phenolic hydroxyl group and an allyl group within the molecule are probably due to the effect of the allyl group contained in the phenolic resin.

From the results presented in FIGS. 4 and 5, it can be understood that the epoxy resin, the phenolic resin, the benzooxazine compound, and the activating agent contained in the flux of the solder paste produce desirable results when the ratio of the number of moles of the epoxy group, the number of moles of the phenolic hydroxyl group, and the number of moles of the dihydrobenzooxazine ring is 100:50 to 124:6 to 50 (number of moles of epoxy group:number of moles of phenolic hydroxyl group:number of moles of dihydrobenzooxazine ring).

The solder paste and the mount structure of the embodiment of the present disclosure are applicable to a wide range of applications in the field of techniques for forming electric/electronic circuits. For example, the disclosure is applicable for bonding of electronic components such as CCD devices, hologram devices, and chip components, and for joining of such components to a substrate. The disclosure is therefore also applicable to products in which such devices, components, and substrates are installed, for example, such as DVD devices, cell phones, portable AV devices, and digital cameras.

What is claimed is:

1. A solder paste comprising a solder powder and a flux,
the flux containing an epoxy resin, a phenolic resin, a benzooxazine compound, and an activating agent,
the phenolic resin containing at least one type of phenolic resin having a phenolic hydroxyl group and an allyl group within the molecule.

2. The solder paste according to claim 1, wherein the number of moles of an epoxy group contained in the epoxy resin, the number of moles of the phenolic hydroxyl group, and the number of moles of a dihydrobenzooxazine ring contained in the benzooxazine compound satisfy the following ratio,
(number of moles of the epoxy group):(number of moles of the phenolic hydroxyl group):(number of moles of the dihydrobenzooxazine ring)=100:50 to 124:6 to 50.

3. The solder paste according to claim 2, wherein the number of moles of the epoxy group, and the sum of the number of moles of the phenolic hydroxyl group and the number of moles of the dihydrobenzooxazine ring satisfy the following formula,
{(number of moles of the phenolic hydroxyl group)+(number of moles of the dihydrobenzooxazine ring)}/(number of moles of the epoxy group)=0.5 to 1.3.

4. The solder paste according to claim 1, wherein the phenolic resin contains a phenolic resin having no allyl group in an amount of 40 mass % or less with respect to a total phenolic resin amount.

5. The solder paste according to claim 1, wherein the benzooxazine compound is a polyvalent oxazine having a plurality of dihydrobenzooxazine rings within the molecule.

6. The solder paste according to claim 1, wherein the solder powder is a Sn—Ag—Cu— or a Sn—Cu-base solder having a melting point of 200° C. or more.

7. The solder paste according to claim 1, wherein the solder powder is contained in a proportion of 5 mass % to 95 mass % with respect to a total mass of the solder paste.

8. The solder paste according to claim 1, wherein the solder paste further comprises a reactive diluent, and the reactive diluent is 1,3-bis[(2,3-epoxypropyl)oxy]benzene.

9. The solder paste according to claim 1, wherein the activating agent is an organic acid, and the organic acid has a melting point of 130° C. to 220° C.

10. A mount structure in which an electronic component is mounted on a circuit board with the solder paste of claim 1,
the mount structure comprising:
a conductive portion where the electronic component and the circuit board are metallurgically bonded to each other; and
a reinforcing portion formed by a cured product of the flux covering a periphery of the conductive portion.

11. The solder paste according to claim 2, wherein the phenolic resin contains a phenolic resin having no allyl group in an amount of 40 mass % or less with respect to a total phenolic resin amount.

12. The solder paste according to claim 3, wherein the phenolic resin contains a phenolic resin having no allyl group in an amount of 40 mass % or less with respect to a total phenolic resin amount.
